(19) United States
(12) Patent Application Publication
(10) Pub. No.: US 2026/0253484 A1
(43) Pub. Date: Aug. 27, 2026

(54) NOTIFICATION SYSTEM, APPARATUS, METHOD, AND COMPUTER-READABLE MEDIUM

(71) Applicant: NEC CORPORATION, Minato-ku, Tokyo (JP)

(72) Inventor: Kazuki INAGAKI, Tokyo (JP)

(21) Appl. No.: 18/726,469

(22) PCT Filed: Feb. 1, 2022
(86) PCT No.: PCT/JP2022/003799

§ 371 Date: Jul. 3, 2024

(51) Int. Cl. G08B 21/22; G06V 20/59; G06V 40/16

(52) U.S. Cl. CPC G08B 21/22; G06V 20/593; G06V 40/172; G06V 40/178

(57) ABSTRACT

A camera captures an image of the inside of a vehicle. A person information acquisition means is configured to acquire person information of a person inside the vehicle from an image of an inside of a vehicle captured by the camera. A determination means determines whether the person inside the vehicle is the person to be monitored based on the person information acquired by person information acquisition means. When the determination means determines that the person inside the vehicle is the person to be monitored, the notification means gives a notification that the person is inside the vehicle.

### TECHNICAL FIELD

The present disclosure relates to a notification system, an apparatus, a method, and a computer-readable medium.

### BACKGROUND ART

As a related art, Patent Literature 1 discloses a system that can easily identify the presence of a person remaining inside a vehicle. In Patent Literature 1, an information processor determines whether there is a person remaining inside the vehicle using image data obtained by capturing an image of the inside of the vehicle from outside the vehicle. When it is determined that there is a person remaining inside the vehicle, the information processor notifies the manager to that effect. Patent Literature 1 also describes that such a notification is given to the manager in the summer season or when the temperature is 23° C. or higher. Patent Literature 2 describes other related arts.

### CITATION LIST

### Patent Literature

Patent Literature 1: Japanese Unexamined Patent Application Publication No. 2019-106703

Patent Literature 2: Japanese Unexamined Patent Application Publication No. 2016-149105

### SUMMARY OF INVENTION

### Technical Problem

In Patent Literature 1, when there is a person remaining inside the vehicle and the temperature is high, the manager is notified to that effect. However, in Patent Literature 1, when the temperature is high, a notification is given to the manager regardless of who is remaining inside the vehicle. Therefore, in Patent Literature 1, for example, a notification is given to the manager not only when an infant who cannot get out of the vehicle by himself/herself is present inside the vehicle, but also even when there is an adult present inside the vehicle.

The present disclosure has been made in view of the aforementioned circumstances and an object of the present disclosure is to provide a notification system, an apparatus, a method, and a computer-readable medium each adapted to reduce the frequency of giving notifications depending on who is remaining inside the vehicle.

### Solution to Problem

To achieve the above object, the present disclosure provides, as a first aspect, a notification apparatus. The notification apparatus includes: person information acquisition means for acquiring person information of a person inside a vehicle from an image of an inside of the vehicle acquired by capturing an image of the inside of the vehicle; determination means for determining, based on the person information, whether the person inside the vehicle is a person to be monitored; and notification means for giving a notification of the presence of a person inside the vehicle when it is determined that the person inside the vehicle is the person to be monitored.

The present disclosure provides, as a second aspect, a notification system. The notification system includes: a camera for capturing an image of the inside of a vehicle; and a notification apparatus for giving a notification when a person to be monitored is left unattended inside the vehicle. The notification apparatus includes: person information acquisition means for acquiring person information of a person inside the vehicle from the image of the inside of the vehicle captured by the camera; determination means for determining, based on the person information, whether the person inside the vehicle is a person to be monitored; and notification means for giving a notification of the presence of a person inside the vehicle when it is determined that the person inside the vehicle is the person to be monitored.

The present disclosure provides, as a third aspect, a notification method. The notification method includes: acquiring person information of a person inside a vehicle from an image of an inside of the vehicle acquired by capturing the image of the inside of the vehicle; determining, based on the person information, whether the person inside the vehicle is a person to be monitored; and giving a notification of the presence of a person inside the vehicle when it is determined that the person inside the vehicle is the person to be monitored.

The present disclosure provides, as a fourth aspect, a computer-readable medium. The non-transitory computer-readable medium stores a program for causing a processor to execute processing including: acquiring person information of a person inside a vehicle from an image of an inside of the vehicle acquired by capturing the image of the inside of the vehicle; determining, based on the person information, whether the person inside the vehicle is a person to be monitored; and giving a notification of the presence of a person inside the vehicle when it is determined that the person inside the vehicle is the person to be monitored.

### Advantageous Effects of Invention

A notification system, an apparatus, a method, and a computer-readable medium according to the present disclosure are each adapted to reduce the frequency of giving notifications depending on who is remaining inside the vehicle.

### BRIEF DESCRIPTION OF DRAWINGS

FIG. 1 is a block diagram schematically showing a notification system according to the present disclosure;

FIG. 2 is a block diagram showing a notification system according to an example embodiment of the present disclosure;

FIG. 3 is a flowchart showing a procedure of operations performed by a notification apparatus; and

FIG. 4 is a block diagram showing an example a hardware configuration of a notification apparatus.

### EXAMPLE EMBODIMENT

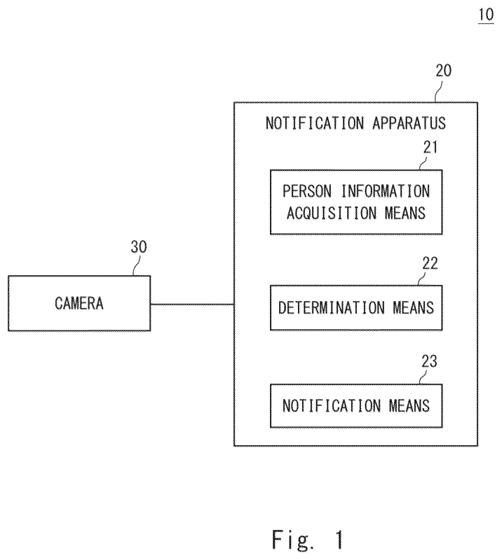

Prior to giving descriptions of the example embodiments of the present disclosure, an overview of the present disclosure will be described. FIG. 1 schematically shows a notification system according to the present disclosure. A notification system 10 includes a notification apparatus 20 and a camera 30. The camera 30 captures an image inside of the vehicle. The notification apparatus 20 is an apparatus for performing notification when a person to be monitored is left unattended inside the vehicle where the camera 30 is installed.

The notification apparatus 20 includes a person information acquisition means 21, a determination means 22, and a notification means 23. The person information acquisition means 21 acquires the person information of the person present inside the vehicle from an image of the inside of the vehicle acquired from the camera 30. The determination means 22 determines whether the person present inside the vehicle is the person to be monitored based on the person information acquired by the person information acquisition means 21. When the determination means 22 determines that the person present inside the vehicle is the person to be monitored, the notification means 23 gives a notification of the presence of a person inside the vehicle.

In the present disclosure, the person information acquisition means 21 acquires the person information of the person inside the vehicle from the image of the inside of the vehicle. The determination means 22 determines whether the person inside the vehicle is the person to be monitored based on the acquired person information. When the person inside the vehicle is determined to be the person to be monitored, the notification means 23 gives a notification. Thus, the notification apparatus 20 can give a notification when the person inside the vehicle is the person to be monitored, and can reduce the frequency of giving notifications depending on the person in the vehicle.

Example embodiments of the present disclosure will be described below with reference to the drawings. The following descriptions and drawings have been omitted and simplified as appropriate for the sake of clarity of the explanation. Further, the same or similar elements are denoted by the same reference symbols throughout the drawings, and redundant descriptions thereof are omitted as appropriate.

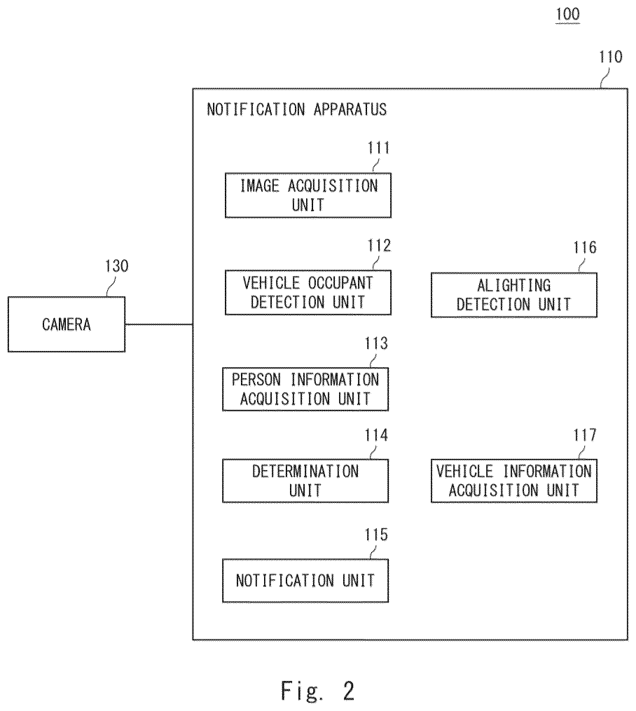

FIG. 2 shows a notification system according to an example embodiment of the present disclosure. A notification system 100 includes a notification apparatus 110 and a camera 130. The camera 130 is mounted on a vehicle and is configured to capture an image of the inside of the vehicle. The vehicle may be a mobile object such as, for example, a passenger car, a taxi, or a van. The camera 130 may be installed at a position from where the whole of the inside of vehicle can be viewed, for example, between the driver's seat and the passenger's seat. Note that the notification system 100 may include more than one camera 130. The notification system 100 may include a plurality of cameras 130 installed in one vehicle. The notification system 100 corresponds to the notification system 10 shown in FIG. 1. The camera 130 corresponds to the camera 30 shown in FIG. 1.

The notification apparatus 110 is an apparatus for performing notification of the presence of a vehicle occupant when a vehicle occupant to be monitored is left unattended inside the vehicle in which the camera 130 is installed. The notification apparatus 110 includes an image acquisition unit 111, a vehicle occupant detection unit 112, a person information acquisition unit 113, a determination unit 114, a notification unit 115, an alighting detection unit 116, and a vehicle information acquisition unit 117. The notification apparatus 110 is an apparatus including, for example, at least one processor and at least one memory. At least some of the functions of the components in the notification apparatus 110 may be implemented by performing processing according to a program read from the memory by the processor. The notification apparatus 110 corresponds to the notification apparatus 20 shown in FIG. 1.

The image acquisition unit 111 acquires a video image of the inside of a vehicle (an image of the inside of a vehicle) captured by the camera 130. The vehicle occupant detection unit 112 detects vehicle occupants who are getting on the vehicle. The vehicle occupant detection unit 112 detects a vehicle occupant by detecting a face area of the subject (the vehicle occupant), for example, from the image of the inside of the vehicle captured by the camera 130. When the image includes a plurality of subjects and a plurality of face areas are detected, the vehicle occupant detection unit 112 detects presence of a plurality of vehicle occupants inside the vehicle. When it is detected that a vehicle occupant has got on a vehicle, the vehicle occupant detection unit 112 assigns an ID (Identifier) to the vehicle occupant. The vehicle occupant detection unit 112 tracks the movement of the vehicle occupant while the vehicle occupant is inside the vehicle.

The person information acquisition unit 113 acquires the person information of the vehicle occupant from the image of the inside of the vehicle captured by the camera 130. The person information acquisition unit 113 acquires attribute information of a vehicle occupant as the person information from, for example, the image of the inside of the vehicle. When presence of a plurality of vehicle occupants are detected, the person information acquisition unit 113 acquires attribute information of each of the plurality of vehicle occupants. The person information acquisition unit 113 may estimate the age of a vehicle occupant based on, for example, an image of a face area of the vehicle occupant, and acquire the estimated age as the attribute information of the vehicle occupant. The person information acquisition unit 113 may estimate the age of a vehicle occupant by, for example, inputting an image of a face area of the vehicle occupant into a trained AI (Artificial Intelligence) model. The person information acquisition unit 113 may specify whether a vehicle occupant is an adult, a child, or an infant according to the estimated age. Alternatively, the person information acquisition unit 113 may perform face authentication on an image of a face area of a vehicle occupant and acquire person information of the vehicle occupant. For example, the person information acquisition unit 113 may perform face authentication to perform person identification and acquire attribute information of the identified person from a database or the like.

Further, the person information acquisition unit 113 may acquire state information of a vehicle occupant as person information in addition to acquiring attribute information of the vehicle occupant or performing person identification. The state information of the vehicle occupant includes, for example, at least one of the health conditions, emotions, body temperature, pulse, and posture of the vehicle occupant. Information on the health conditions and emotions of the vehicle occupant can be estimated, for example, by using a trained AI model. Vehicle occupant's body temperature can be obtained, for example, by analyzing a video image taken by an infrared camera. Vehicle occupant's pulse and posture can be obtained by analyzing an image of the inside of a vehicle. The person information acquisition unit 113 corresponds to the person information acquisition means 21 shown in FIG. 1.

The vehicle information acquisition unit (vehicle information acquisition means) 117 acquires vehicle information of a vehicle. The vehicle information may include information indicating the operating status of an air conditioner and information indicating whether the door is locked. The vehicle information acquisition unit 117 may acquire vehicle information from a device such as an ECU (Electronic Control Unit) that controls a vehicle via an in-vehicle network such as a CAN (Controller Area Network).

The alighting detection unit (alighting detection means) 116 detects that a vehicle occupant who was inside the vehicle has alighted from the vehicle. The alighting detection unit 116 determines that, for example, in the case where the presence of a vehicle occupant to which a certain ID is assigned is no longer detected inside the vehicle, the vehicle occupant has alighted from the vehicle. The alighting detection unit 116 may be configured to detect the opening and closing of the vehicle door, and determine that the vehicle occupant has alighted from the vehicle when the presence of a vehicle occupant to which a certain ID is assigned is no longer detected in the vehicle after the vehicle door is opened. The alighting detection unit 116 holds information for identifying the last vehicle occupant to have alighted from the vehicle in the case where the vehicle occupants are identified by face authentication or the like.

The determination unit 114 determines whether the vehicle occupant is a person to be monitored based on the person information acquired by the person information acquisition unit 113. The determination unit 114 determines, for example, whether the person information matches the conditions of the person to be monitored. The conditions of the person to be monitored includes, for example, information identifying the person to be monitored. When the person is identified by face authentication or the like in the person information acquisition unit 113, the determination unit 114 determines whether the vehicle occupant is the person designated as the person to be monitored. When the vehicle occupant is the person designated as the person to be monitored, the determination unit 114 determines that the vehicle occupant is the person to be monitored.

When the attribute information of the vehicle occupant is acquired by the person information acquisition unit 113, the determination unit 114 may determine whether the attribute information of the vehicle occupant matches the attribute information designated as the conditions of the person to be monitored. For example, the determination unit 114 acquires the age (the estimated age) of the vehicle occupant as the attribute information. The determination unit 114 determines whether the age of a vehicle occupant falls within the age range designated as the conditions of the person to be monitored. When the age of the vehicle occupant falls within the age range designated as the conditions of the person to be monitored, the determination unit 114 may determine that the vehicle occupant is the person to be monitored.

When the state information of a vehicle occupant is acquired by the person information acquisition unit 113, the determination unit 114 may determine whether the state information of the vehicle occupant matches the state information designated as the conditions of the person to be monitored. For example, the determination unit 114 determines whether the health conditions or emotions of the vehicle occupant match the health conditions or emotions designated as the conditions of the person to be monitored in the case where information on the health conditions or emotions of the vehicle occupant have been obtained as the state information. The determination unit 114 may determine that the vehicle occupant is a person to be monitored in the case where the health conditions or emotions of the vehicle occupant match those specified as conditions of the person to be monitored. The determination unit 114 may determine whether a vehicle occupant is in a limp, slumped position when the posture of the vehicle occupant is acquired as state information. The determination unit 114 may determine that the vehicle occupant is the person to be monitored when the vehicle occupant is slumped in the seat.

The determination unit 114 may determine whether the vehicle occupant is the person to be monitored based on the vehicle information acquired by the vehicle information acquisition unit 117. For example, the determination unit 114 may determine whether a vehicle occupant is the person to be monitored when all the vehicle doors are locked and the air conditioner is not operating. The determination unit 114 may determine whether the person to be monitored is left unattended inside the vehicle according to whether there is a person other than the person to be monitored present inside the vehicle. The determination unit 114 corresponds to the determination means 22 shown in FIG. 1.

When the determination unit 114 determines that a vehicle occupant is a person to be monitored, the notification unit 115 configured to give a notification of the presence of a person present inside the vehicle. For example, when the only vehicle occupant present inside the vehicle is the person to be monitored present, the notification unit 115 gives a notification to that effect. In other words, the notification unit 115 gives a notification when a person other than the person to be monitored has alighted from the vehicle. The notification unit 115 may give a notification when the determination unit 114 determines that the person to be monitored is left unattended inside the vehicle. The notification unit 115 may give a notification after a predetermined time from the time when it is first determined that the person to be monitored is left unattended inside the vehicle. For example, the notification unit 115 may give a notification when the person to be monitored is left unattended inside the vehicle even after a predetermined time has elapsed from the time when it is first determined that the person to be monitored is left unattended inside the vehicle. The notification unit 115 may transmit the current image of the inside of the vehicle that the camera 130 has captured to the recipient of the notification. Alternatively, the notification unit 115 may transmit the live video image of the inside the vehicle that the camera 130 has captured to the recipient of the notification.

For example, the notification unit 115 gives a notification that the person to be monitored is left unattended inside the vehicle to a terminal device held by the person who last alighted from the vehicle detected by the alighting detection unit 116. The notification unit 115 may, for example, use a cellular phone network or near-field communication to give a notification that the person to be monitored is left unattended inside the vehicle to a terminal device held by the person who last alighted from the vehicle. The notification unit 115 may transmit a message to a predetermined destination of the notification indicating that the person is left unattended inside the vehicle. When the recipient of the notification reads the message, the notification unit 115 may acquire information indicating that the message has been read. In the case where the recipient of the notification does not read the message after a predetermined time has elapsed after the message has been sent, the notification unit 115 may send the message to another recipient of the notification. For example, when the message is sent by e-mail, the notification unit 115 may send the message to another recipient of the notification in the case where the e-mail is not opened after 10 minutes have elapsed after the e-mail has been sent. The notification unit 115 may use a display device or a sound device to inform those around the vehicle that there is a person left unattended inside the vehicle. The notification unit 115 corresponds to the notification unit 23 shown in FIG. 1.

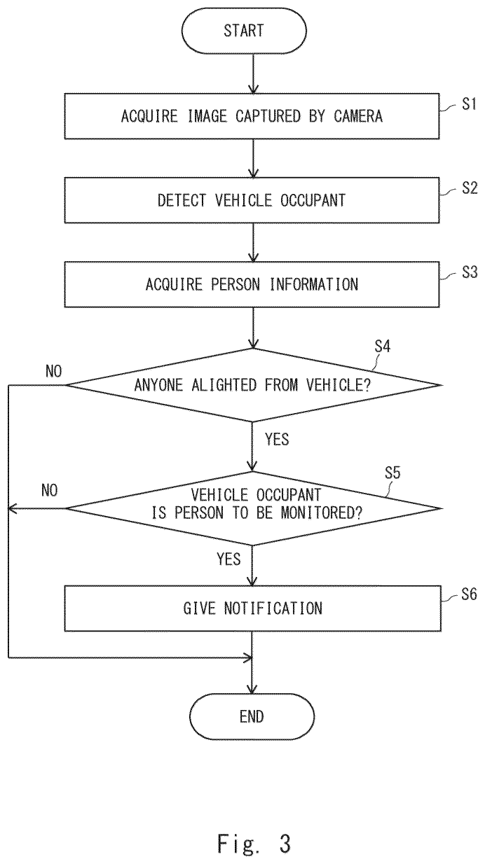

Next, a procedure of operations will be described. FIG. 3 shows a procedure of operations (a notification method) performed by the notification apparatus 110. The image acquisition unit 111 acquires an image of the inside of the vehicle from the camera 130 (Step S1). The vehicle occupant detection unit 112 detects presence of a vehicle occupant inside the vehicle (Step S2). In Step S2, the vehicle occupant detection unit 112 detects a vehicle occupant by, for example, detecting a face area of the vehicle occupant from the image of the inside of the vehicle. The person information acquisition unit 113 acquires the person information of the vehicle occupant who has been detected (Step S3). The person information acquisition unit 113 acquires the person information in the case where a person identification is performed by using face authentication, in the case where the attributes of the person are estimated from the image of the face area, or in the case where presence of a vehicle occupant inside the vehicle is detected for the first time. In the case where the state information of the vehicle occupant is to be acquired, the person information acquisition unit 113 acquires the person information of a vehicle occupant continuously.

The alighting detection unit 116 determines whether there is any vehicle occupant who has alighted from the vehicle (Step S4). In Step S4, the alighting detection unit 116 determines where there has been an increase or decrease in the number of vehicle occupants from, for example, a change in the result of vehicle occupant detection performed by the vehicle occupant detection unit 112 in Step S2. When the number of vehicle occupants has decreased, the alighting detection unit 116 determines that there is a vehicle occupant who has alighted from the vehicle. The alighting detection unit 116 may record the person information of the vehicle occupant who last alighted from the vehicle.

The determination unit 114 determines whether the vehicle occupant is a monitoring target (Step S5). For example, in Step S5, the determination unit 114 determines whether the vehicle occupant is a target to be monitored by comparing the person information of the vehicle occupant with the conditions of the person to be monitored. When the vehicle occupant present inside the vehicle is only the monitoring target, the notification unit 115 gives a notification of the presence of a person left unattended inside the vehicle (Step S6). In Step S6, the notification unit 115 may give a notification of the presence of a person left unattended inside the vehicle to a terminal device held by the person who last alighted from the vehicle.

In the present example embodiment, the person information acquisition unit 113 acquires the person information of the vehicle occupant. The notification unit 115 gives a notification when it is determined that the vehicle occupant is a person to be monitored by the determination unit 114, not just when a person is left unattended in a vehicle. In the case of simply determining whether there is a person is left unattended inside the vehicle and giving a notification to that effect, even when the person left unattended inside the vehicle is a person who is capable of getting out of the vehicle by himself/herself, a notification as to the fact that there is a person left unattended inside the vehicle is given nevertheless. In contrast, in the present example embodiment, the person information is acquired, and it is determined from the person information whether the person in the vehicle is a person to be monitored. In this example embodiment, the notification apparatus 110 can give a notification that a person is left unattended inside the vehicle when the person left unattended inside the vehicle is a person to be monitored. Thus, by deciding whether to give a notification in response to the person information of the person present inside the vehicle, it is possible to give a notification when the person who needs to be reported of his/her unattended lone presence in the vehicle is left unattended inside the vehicle, and it is possible to reduce the frequency of giving notifications.

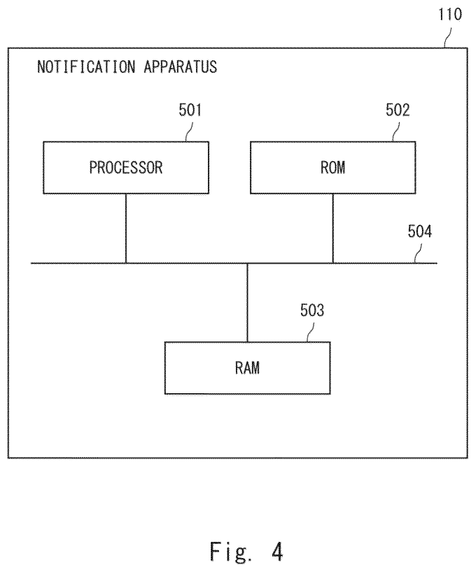

Next, the hardware configuration of the notification apparatus 110 will be described. FIG. 4 shows an example of the hardware configuration of the notification apparatus 110. The notification apparatus 110 includes a processor (CPU: Central Processing Unit) 501, a read only memory (ROM) 502, and a random access memory (RAM) 503. In the notification apparatus 110, the processor 501, the ROM502, and the RAM503 are connected to one another via a bus 504. The notification apparatus 110 may include other circuits such as a peripheral circuit, a communication circuit, and an interface circuit, although they are not illustrated.

The ROM502 is a non-volatile storage device. The ROM 502 may be, for example, a semiconductor storage device such as a flash memory with a relatively low capacity. The ROM502 stores a program executed by the processor 501.

The program includes instructions (or software code) for causing the computer to perform one or more functions described in example embodiment when read into the computer. The program may be stored in a non-transitory computer-readable medium or a tangible storage medium. By way of example, and not a limitation, non-transitory computer readable media or tangible storage media can include a RAM, a ROM, a flash memory, a solid-state drive (SSD) or other types of memory technologies, a Compact Disc (CD), a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The RAM 503 is a volatile storage device. The RAM 503 may be various semiconductor memory devices such as a Dynamic Random Access Memory (DRAM) or a Static Random Access Memory (SRAM). The RAM 503 may be used as an internal buffer that temporarily stores data or the like.

The processor 501 deploys the program stored in the ROM502 to the RAM503 and executes the deployed program. The CPU 501 executes the program, whereby functions of the respective units in the authentication apparatus 110 may be implemented.

Note that the notification apparatus 110 may not necessarily be a single apparatus. The notification apparatus 110 may be configured using a plurality of apparatuses physically separated from one another. In addition, the notification apparatus 110 does not necessarily have to have all the functions installed in the vehicle. For example, in the notification apparatus 110, at least a part of the functions of the vehicle occupant detection unit 112, the person information acquisition unit 113, and the determination unit 114 may be disposed outside the vehicle. In this case, for example, the vehicle occupant detection unit 112 may receive the video image of the inside of the vehicle that the camera 130 has captured through the wireless communication network.

Although example embodiments of the present disclosure have been described in detail above, the present disclosure is not limited to example embodiment described above, and changes or modifications to example embodiment described above are included in the present disclosure to the extent that they do not deviate from the purpose of the present disclosure.

For example, some or all of the above-mentioned example embodiment may be described as in the following supplementary note, but not limited to the following.

### Supplementary Note 1

A notification apparatus including:
person information acquisition means for acquiring person information of a person inside a vehicle from an image of an inside of the vehicle acquired by capturing an image of the inside of the vehicle;
determination means for determining, based on the person information, whether the person inside the vehicle is a person to be monitored; and
notification means for giving a notification of the presence of a person inside the vehicle when it is determined that the person inside the vehicle is the person to be monitored.

### Supplementary Note 2

The notification apparatus described in Supplementary Note 1, wherein the person information acquisition means is configured to acquire attribute information of the person inside the vehicle from the image of the inside of the vehicle as the person information.

### Supplementary Note 3

The notification apparatus described in Supplementary Note 2, wherein the person information acquisition means is configured to estimate the age of the person inside the vehicle based on an image of a face area detected based on the image of the inside of the vehicle and acquire the estimated age as the attribute information.

### Supplementary Note 4

The notification apparatus described in Supplementary Note 2, wherein the person information acquisition means is configured to acquire the person information by performing face authentication on an image of a face area detected based on the image of the inside of the vehicle.

### Supplementary Note 5

The notification apparatus described in Supplementary Note 4, wherein the person information acquisition means is configured to identify the person inside the vehicle by performing face authentication.

### Supplementary Note 6

The notification apparatus described in any one of Supplementary Notes 1 to 5, wherein the person information acquisition means is configured to acquire state information of the person inside the vehicle as the person information.

### Supplementary Note 7

The notification apparatus described in any one of Supplementary Notes 1 to 6, further including vehicle information acquisition means for acquiring vehicle information of the vehicle,
wherein the determination means is configured to perform determination as to whether the person inside the vehicle is a person to be monitored in accordance with the acquired vehicle information.

### Supplementary Note 8

The notification apparatus described in any one of Supplementary Notes 1 to 7, wherein
the determination means is configured to perform further determination as to whether the person to be monitored is left unattended inside the vehicle in accordance with whether there is a person other than the person to be monitored present inside the vehicle, and
the notification means is configured to give a notification of the presence of a person inside the vehicle when it is determined that there is the person to be monitored left unattended inside the vehicle.

### Supplementary Note 9

The notification apparatus described in any one of Supplementary Notes 1 to 8, further including alighting detection means for detecting that the person inside the vehicle has alighted from the vehicle,
wherein the notification means is configured to give a notification of the presence of a person present inside the vehicle when a person other than the person to be monitored has alighted from the vehicle.

### supplementary Note 10

The notification apparatus described in Supplementary Note 9, wherein the notification means is configured to give a notification of the presence of a person present inside the vehicle to the last person who alighted from the vehicle.

### Supplementary Note 11

A notification system including:
a camera for capturing an image of the inside of a vehicle; and
a notification apparatus for giving a notification when a person to be monitored is left unattended inside the vehicle,
the notification apparatus including:
   person information acquisition means for acquiring person information of a person inside the vehicle from the image of the inside of the vehicle captured by the camera;
   determination means for determining, based on the person information, whether the person inside the vehicle is a person to be monitored; and
   notification means for giving a notification of the presence of a person inside the vehicle when it is determined that the person inside the vehicle is the person to be monitored.

### Supplementary Note 12

The notification system described in Supplementary Note 11, wherein the person information acquisition means is configured to acquire attribute information of the person inside the vehicle as the person information from the image of the inside of the vehicle.

### Supplementary Note 13

The notification system described in Supplementary Note 12, wherein
the determination means is configured to further determine whether the person to be monitored is left unattended inside the vehicle according to whether a person other than the person to be monitored is present inside the vehicle,
the notification means is configured to give a notification of the presence of a person inside the vehicle when it is determined that the person to be monitored is left unattended inside the vehicle.

### Supplementary Note 14

A Notification Method Including:
acquiring person information of a person inside a vehicle from an image of an inside of the vehicle acquired by capturing the image of the inside of the vehicle;
determining, based on the person information, whether the person inside the vehicle is a person to be monitored; and
giving a notification of the presence of a person inside the vehicle when it is determined that the person inside the vehicle is the person to be monitored.

### Supplementary Note 15

A non-transitory computer-readable medium storing a program for causing a processor to execute processing including:
acquiring person information of a person inside a vehicle from an image of an inside of the vehicle acquired by capturing the image of the inside of the vehicle;
determining, based on the person information, whether the person inside the vehicle is a person to be monitored; and
giving a notification of the presence of a person inside the vehicle when it is determined that the person inside the vehicle is the person to be monitored.

### REFERENCE SIGNS LIST

10: NOTIFICATION SYSTEM
20: NOTIFICATION APPARATUS
21: PERSON INFORMATION ACQUISITION MEANS
22: DETERMINATION MEANS
23: NOTIFICATION MEANS
30: CAMERA
100: NOTIFICATION SYSTEM
110: NOTIFICATION APPARATUS
112: VEHICLE OCCUPANT DETECTION UNIT
113: PERSON INFORMATION ACQUISITION UNIT
114: DETERMINATION UNIT
115: NOTIFICATION UNIT
116: ALIGHTING DETECTION UNIT
117: VEHICLE INFORMATION ACQUISITION UNIT
130: CAMERA
501: PROCESSOR
502: ROM
503: RAM
504: BUS

What is claimed is:

1. A notification apparatus comprising:
at least one memory storing instructions; and
at least one processor configured to execute the instructions to:
acquire person information of a person inside a vehicle from an image of an inside of the vehicle acquired by capturing an image of the inside of the vehicle;
determine, based on the person information, whether the person inside the vehicle is a person to be monitored; and
give a notification of the presence of a person inside the vehicle when it is determined that the person inside the vehicle is the person to be monitored.

2. The notification apparatus according to claim 1, wherein the at least one processor is configured to execute the instructions to acquire attribute information of the person inside the vehicle from the image of the inside of the vehicle as the person information.

3. The notification apparatus according to claim 2, wherein the at least one processor is configured to execute the instructions to estimate an age of the person inside the vehicle based on an image of a face area detected based on the image of the inside of the vehicle and acquire the estimated age as the attribute information.

4. The notification apparatus according to claim 2, wherein the at least one processor is configured to execute the instructions to acquire the person information by performing face authentication on an image of a face area detected based on the image of the inside of the vehicle.

5. The notification apparatus according to claim 4, wherein the at least one processor is configured to execute the instructions to identify the person inside the vehicle by performing face authentication.

6. The notification apparatus according to claim 1, wherein the at least one processor is configured to execute the instructions to acquire state information of the person inside the vehicle as the person information.

7. The notification apparatus according to claim 1, wherein the at least one processor is configured to execute the instructions to:
acquire vehicle information of the vehicle, and
perform determination as to whether the person inside the vehicle is a person to be monitored in accordance with the acquired vehicle information.

8. The notification apparatus according to claim 1, wherein the at least one processor is configured to execute the instructions to:
perform further determination as to whether the person to be monitored is left unattended inside the vehicle in accordance with whether there is a person other than the person to be monitored present inside the vehicle, and
to give a notification of the presence of a person inside the vehicle when it is determined that there is the person to be monitored left unattended inside the vehicle.

9. The notification apparatus according to claim 1, wherein the at least one processor is configured to execute the instructions to:
detect that the person inside the vehicle has alighted from the vehicle, and
give a notification of the presence of a person present inside the vehicle when a person other than the person to be monitored has alighted from the vehicle.

10. The notification apparatus according to claim 9, wherein the at least one processor is configured to execute the instructions to give a notification of the presence of a person present inside the vehicle to the last person who alighted from the vehicle.

11. A notification system comprising:
a camera for capturing an image of the inside of a vehicle; and
the notification apparatus according to claim 1.

12. The notification system according to claim 11, wherein the at least one processor is configured to execute the instructions to acquire attribute information of the person inside the vehicle as the person information from the image of the inside of the vehicle.

13. The notification system according to claim 12, wherein the at least one processor is configured to execute the instructions to:
determine whether the person to be monitored is left unattended inside the vehicle according to whether a person other than the person to be monitored is present inside the vehicle, and
give a notification of the presence of a person inside the vehicle when it is determined that the person to be monitored is left unattended inside the vehicle.

14. A notification method comprising:
acquiring person information of a person inside a vehicle from an image of an inside of the vehicle acquired by capturing the image of the inside of the vehicle;
determining, based on the person information, whether the person inside the vehicle is a person to be monitored; and
giving a notification of the presence of a person inside the vehicle when it is determined that the person inside the vehicle is the person to be monitored.

15. A non-transitory computer-readable medium storing a program for causing a processor to execute processing including:
acquiring person information of a person inside a vehicle from an image of an inside of the vehicle acquired by capturing the image of the inside of the vehicle;
determining, based on the person information, whether the person inside the vehicle is a person to be monitored; and
giving a notification of the presence of a person inside the vehicle when it is determined that the person inside the vehicle is the person to be monitored.
